(19) United States
(12) Patent Application Publication
(10) Pub. No.: US 2012/0285915 A1
(43) Pub. Date: Nov. 15, 2012

(54) INTERCHANGEABLE SHELF DISPLAY SURFACE

(76) Inventors: Taft O'Quinn, Inola, OK (US); Michael Martin, Fayetteville, AR (US); Carrie Martin, Fayetteville, AR (US); Val-Jean Duchene, Centerton, AR (US)

(21) Appl. No.: 13/327,568

(22) Filed: Dec. 15, 2011

Related U.S. Application Data
(60) Provisional application No. 61/423,395, filed on Dec. 15, 2010.

(51) Int. Cl. A47B 96/06; B23P 17/04; A47B 96/02

(52) U.S. Cl. 211/134; 29/401.1

(57) ABSTRACT

An interchangeable shelf display surface for a shelving system includes a removable display surface featuring a top side and a bottom side. A securing arrangement is adapted to secure the bottom side of the removable display surface to the shelving system.

### CLAIM OF PRIORITY

This application claims priority to provisional patent application No. 61/423,395, filed Dec. 15, 2010, currently pending.

### FIELD OF THE INVENTION

The present invention generally relates to retail shelving systems and, more particularly, to an interchangeable display surface for the shelves of retail shelving systems.

### BACKGROUND OF THE INVENTION

In an effort to improve the aesthetic appeal of store environments and to create a more pleasant atmosphere, retailers are increasingly requesting unique finishes, such as two-tone color schemes, granite and wood grain, on the shelves of their shelving systems. Applying these finishes to shelves post-manufacture is time consuming and costly.

Additionally, years of wear and tear on shelf display surfaces lead to marred and scratched display surfaces. Prior art designs require the removal of entire shelves to be returned to the manufacturer or the like for refinishing to restore an acceptable aesthetic surface. A need therefore exists for a device or method that would allow for the removal and replacement of the damaged shelf display surface without the time and expense involved with the traditional refinishing processes.

In addition, a need exists for an interchangeable shelf display surface to open up an opportunity for retailers to change display surfaces on a seasonal basis to create new and unique aesthetics to enhance the shopping experience.

### BRIEF DESCRIPTION OF THE DRAWINGS

FIG. 1 is a top side perspective, partially cutaway view of an example of a prior art shelf that is suitable for use with an embodiment of the interchangeable shelf display surface of the present invention;

FIG. 2 is bottom side perspective view of a first embodiment of the interchangeable shelf display surface of the present invention;

FIG. 3 is a top side perspective view of a second embodiment of the interchangeable shelf display surface of the present invention;

FIG. 4A is a top side perspective view of a third embodiment of the interchangeable shelf display surface of the present invention in the process of being installed on a shelf;

FIG. 4B is a top side perspective view of the installed interchangeable shelf display surface of FIG. 4A;

FIG. 5 is a top side perspective view of the interchangeable shelf display surface of FIG. 3 installed on a shelf of a retail shelving system;

FIG. 6 is a bottom side perspective view of the interchangeable shelf display surface of FIGS. 4A and 4B.

### DETAILED DESCRIPTION OF EMBODIMENTS

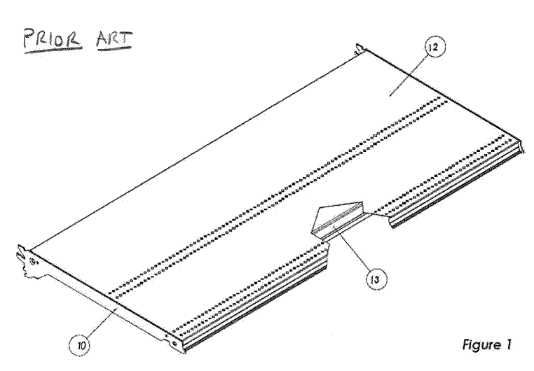

FIG. 1 shows the functional elements of a prior art shelf of a retail shelving system. The shelf is composed of two end brackets 10, a shelf pan 12 and at least one longitudinal support 13. The components are constructed of metal and are typically mechanically attached to each other by spot and mig welds.

The present invention provides an interchangeable shelf display surface for shelves such as the one illustrated in FIG. 1.

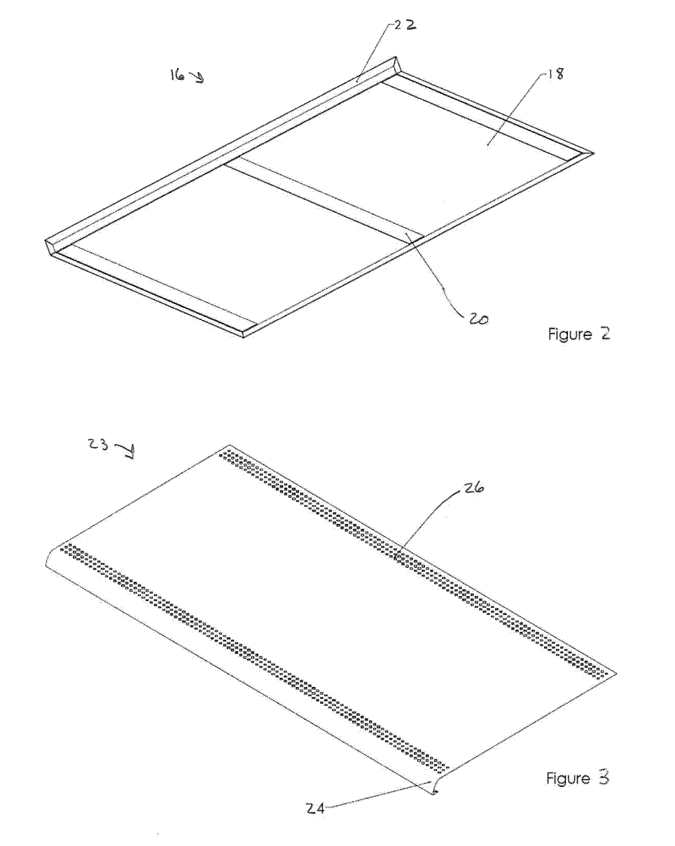

An embodiment of the interchangeable shelf display surface of the present invention is indicated in general at 16 in FIG. 2. The interchangeable shelf display surface consists of two elements: a removable display surface 18, preferably fabricated from pre-coated steel to provide aesthetic appeal, and magnetic strips 20 applied to the bottom of the display surface 18 to attach it to the metal shelf pan (12 in FIG. 1) of a shelf. The magnetic strips 20 may be secured to the bottom of the display surface 18 by adhesive or other fastening means, or may merely be held in place by magnetic attraction.

To eliminate sharp edges, the entire perimeter of the interchangeable shelf display surface is preferably hemmed, as indicated at 22 in FIG. 2.

As an alternative to the magnetic strips 20 of FIG. 2, alternative temporary securing arrangements known in the art may be used to hold the interchangeable shelf display surface to the shelf pan (12 of FIG. 1). These may include, but are not limited to, magnets of other shapes, adhesives, hook and loop fasteners (such as VELCRO), snaps, tape (such as 2-sided) etc.

As an alternative to steel, the removable display surface may be constructed from any other rigid, semi-rigid or flexible material including, but not limited to plastic, wood, cardboard or paper.

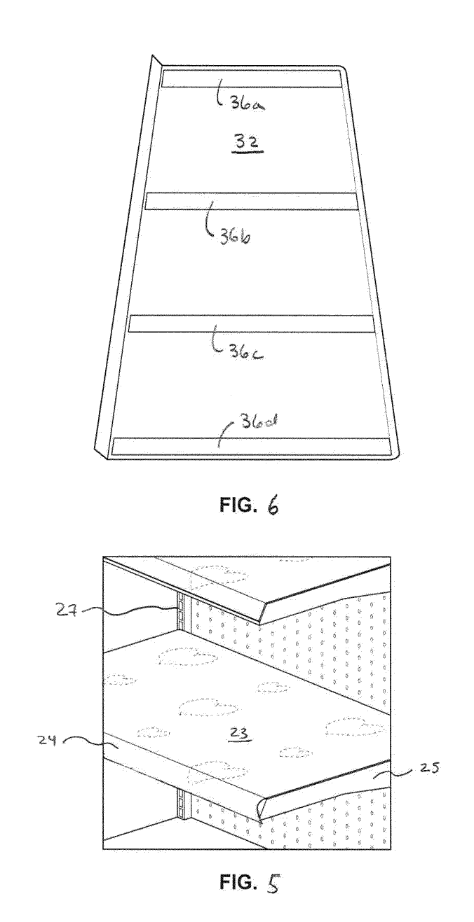

In an alternative embodiment, indicated in general at 23 in FIG. 3, the interchangeable shelf display surface of the present invention can be fabricated with a rounded front edge 24 to change the appearance of a slant nose shelf such that it looks like a bull nosed version. See FIG. 5 where the interchangeable shelf display surface 23 is installed on shelf 25 of retail shelving system 27. As illustrated in FIG. 3, perforations 26 can optionally be included in the interchangeable shelf display surface 23 to align with those on existing shelves.

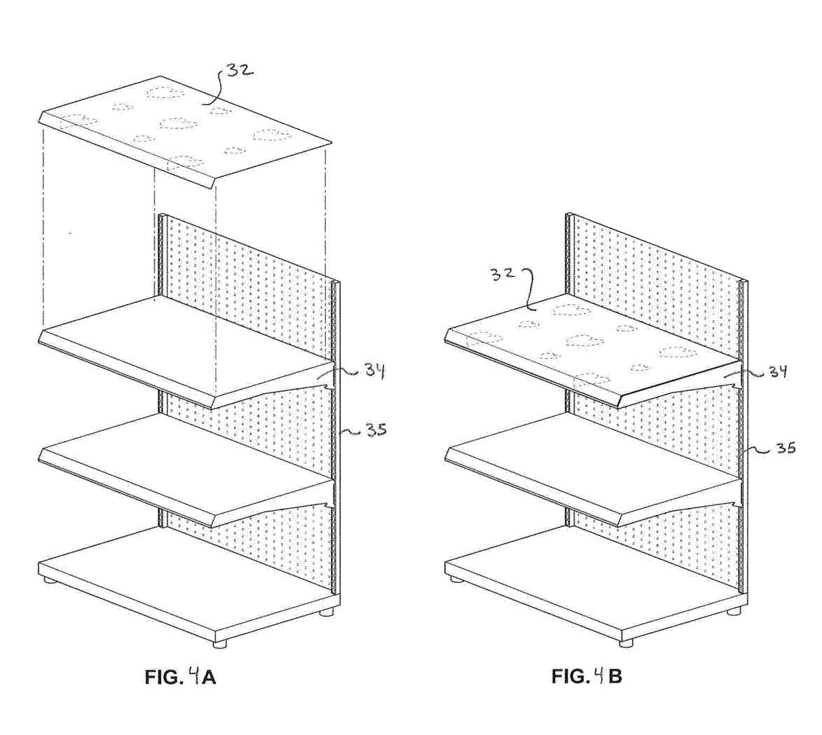

Another alternative embodiment of the interchangeable shelf display surface is shown at 32 in FIGS. 4A and 4B installed on a metal shelf 34 of a retail shelving system 35. The interchangeable shelf display surface 32 is secured in place by magnetic strips applied to the bottom (not visible in FIGS. 4A and 4B), illustrated at 36a-36d in FIG. 6.

While the preferred embodiments of the invention have been shown and described, it will be apparent to those skilled in the art that changes and modifications may be made therein without departing from the spirit of the invention, the scope of which is defined by the appended claims.

What is claimed is:

1. An interchangeable shelf display surface for a shelving system comprising:
a. a removable display surface featuring a top side and a bottom side;
b. a securing arrangement adapted to secure the bottom side of the removable display surface to the shelving system.

2. The interchangeable shelf display surface of claim 1 wherein the securing arrangement includes magnetic strips.

3. The interchangeable shelf display surface of claim 2 wherein the magnetic strips are secured to the bottom side of the removable display surface by adhesive.

4. The interchangeable shelf display surface of claim 1 wherein the securing arrangement includes an adhesive.

5. The interchangeable shelf display surface of claim 1 wherein the securing arrangement includes hook and loop fasteners.

6. The interchangeable shelf display surface of claim 1 wherein the securing arrangement includes tape.

7. The interchangeable shelf display surface of claim 1 wherein the securing arrangement includes snaps.

8. The interchangeable shelf display surface of claim 1 wherein the removable display surface has hemmed edges.

9. The interchangeable shelf display surface of claim 1 wherein the removable display surface has perforations.

10. The interchangeable shelf display surface of claim 1 wherein the removable display surface is constructed from metal.

11. The interchangeable shelf display surface of claim 1 wherein the removable display surface is constructed from plastic.

12. The interchangeable shelf display surface of claim 1 wherein the removable display surface includes a rounded front edge.

13. A method of changing a shelf display surface of a shelving system comprising the steps of:
a. providing a removable display surface featuring a top side and a bottom side and a securing arrangement; and
b. removably securing the bottom side of the removable display surface to the shelf display surface of the shelving system.

14. The method of claim 13 wherein the securing arrangement includes magnetic strips.

15. The method of claim 14 wherein the magnetic strips are secured to the bottom side of the removable display surface by adhesive.

16. The method of claim 13 wherein the securing arrangement includes an adhesive.

17. The method of claim 13 wherein the securing arrangement includes hook and loop fasteners.

18. The method of claim 13 wherein the securing arrangement includes tape.

19. The method of claim 13 wherein the securing arrangement includes snaps.

20. The method of claim 13 wherein the removable display surface is constructed from metal.
